(19) United States
(12) Patent Application Publication
(10) Pub. No.: US 2024/0168653 A1
(43) Pub. Date: May 23, 2024

(54) MEMORY SYSTEM ADAPTIVE TO HEALTH CONDITION, AND MEMORY CONTROLLER FOR MEMORY SYSTEM AND OPERATING METHOD OF THE MEMORY SYSTEM

(71) Applicant: SK hynix Inc., Icheon-si Gyeonggi-do (KR)

(72) Inventor: Sang Sik KIM, Icheon-si Gyeonggi-do (KR)

(73) Assignee: SK hynix Inc., Icheon-si Gyeonggi-do (KR)

(21) Appl. No.: 18/329,380

(22) Filed: Jun. 5, 2023

(30) Foreign Application Priority Data
Nov. 17, 2022 (KR) 10-2022-0154748

(51) Int. Cl. G06F 3/06

(52) U.S. Cl. CPC G06F 3/0619; G06F 3/0653; G06F 3/0659; G06F 3/0679

(57) ABSTRACT

A memory system including a storage device comprising a plurality of memory blocks comprising a plurality of pages; and a memory controller configured to update and maintain a page address that is included in a weak page table, based on a number of fail bits for each page that has been accessed based on a page address on which a normal read operation has been indicated, and configured to perform a maintenance operation on the storage device every preset cycle based on the weak page table.

### CROSS-REFERENCES TO RELATED APPLICATION

The present application claims priority under 35 U.S.C. § 119(a) to Korean application number 10-2022-0154748, filed on Nov. 17, 2022, in the Korean Intellectual Property Office, which is incorporated herein by reference in its entirety.

### BACKGROUND

### 1. Technical Field

The present technology generally relates to a semiconductor integrated device, and more particularly, to a memory system adaptive to a health condition, and a memory controller for the memory system and an operating method of the memory system.

### 2. Related Art

A memory system performs a data input and output operation in response to a request from an external device by using a volatile or nonvolatile memory device as a storage medium.

In order to prevent a loss of data that has been stored in a memory device that is used as the storage medium, various maintenance methods are used. The reliability of data that has been stored in the memory device can be secured by performing a data maintenance operation every certain cycle.

As the memory system is repeatedly used, a data retention characteristic of the memory device may be changed.

Accordingly, it is necessary to perform the maintenance operation adaptively to a change in the characteristic of the memory device.

### SUMMARY

A memory system according to an embodiment of this technology may include: a storage device comprising a plurality of memory blocks comprising a plurality of pages; and a memory controller configured to update and maintain a page address that is included in a weak page table, based on a number of fail bits for each page that has been accessed based on a page address on which a normal read operation has been indicated, and configured to perform a maintenance operation on the storage device every preset cycle based on the weak page table.

A memory controller according to an embodiment of this technology may include: a weak page table in which a set number of page addresses have been stored; scan and refresh (scan/refresh) logic configured to perform a maintenance operation by accessing a storage device every preset cycle based on the weak page table; and a weak page tracking circuit configured to update and maintain a page address that is included in the weak page table, based on a number of fail bits for each page that has been accessed based on a page address on which a normal read operation has been indicated.

An operating method of a memory system according to an embodiment of this technology may include: reading, by a memory controller configured to control a storage device comprising a plurality of memory blocks comprising a plurality of pages, data by accessing a page corresponding to a page address on which a normal read operation has been indicated; updating and maintaining, by the memory controller, a page address that is included in a weak page table, based on a number of fail bits for each page accessed for the normal read operation; and performing, by the memory controller, a maintenance operation every preset cycle based on the weak page table.

### BRIEF DESCRIPTION OF THE DRAWINGS

FIG. 1 is a construction diagram of a memory system according to an embodiment.

FIG. 2 is a construction diagram of a storage device according to an embodiment.

FIG. 3 is a construction diagram of a maintenance circuit according to an embodiment.

FIG. 4 is a diagram for describing the concept of a weak page table update according to an embodiment.

FIG. 5 is a diagram for describing the concept of a weak page table update according to an embodiment.

FIG. 6 is a flowchart for describing an operating method of the memory system according to an embodiment.

FIG. 7 is a flowchart for describing an operating method of the memory system according to an embodiment.

### DETAILED DESCRIPTION

Hereinafter, embodiments of the present technology will be described in more detail with reference to the accompanying drawings.

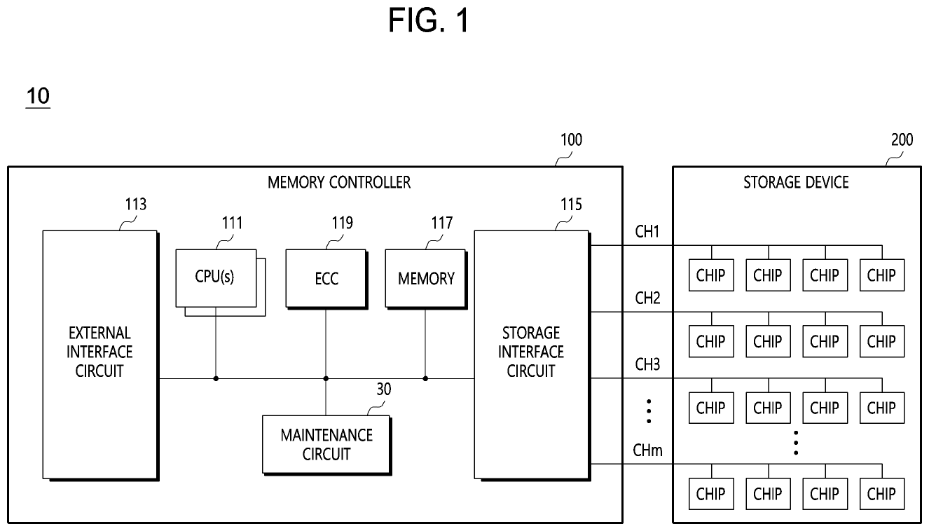

FIG. 1 is a construction diagram of a memory system according to an embodiment.

Referring to FIG. 1, a memory system 10 may include a memory controller 100 and a storage device 200. The memory system may be electrically connected to an external device (not illustrated), and may exchange data with the external device.

The external device may be selected from various types of computing systems, such as a personal computer, a laptop computer, a server computer, a workstation, a tablet PC, a drone, an advanced driver's assistance system (ADAS), a smart TV, a smartphone, a medical device, an image display device, a measuring device, and an Internet of Things (IoT) device.

The storage device 200 may include at least one of a volatile memory device and a nonvolatile memory device. The storage device 200 may be connected to the memory controller 100 through a plurality of channels CH1, CH2, CH3 to CHm, and may include a plurality of memory chips (CHIP) or a plurality of packages.

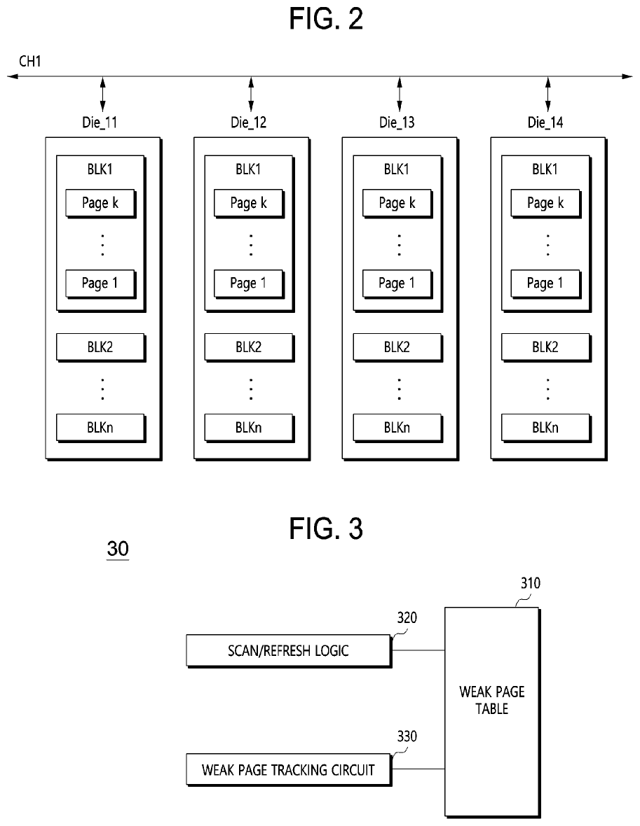

FIG. 2 is a construction diagram of the storage device according to an embodiment.

Each of the memory chips that constitute the storage device 200 may include a plurality of memory dies Die_11 to Die_14.

The memory controller 100 may be connected to the plurality of dies Die_11 to Die_14 through a channel CH. The number of channels or the number of dies that is connected to each channel is not limited to the examples illustrated in FIGS. 1 and 2.

Each of the dies Die_11 to Die_14 may include one or more planes. For convenience of description, FIG. 2 illustrates that one die includes one plane.

One plane may include a plurality of memory blocks BLK1 to BLKn (n is a natural number equal to or greater than 1). Each of the memory blocks may include a plurality of pages 1 to page k (k is a natural number equal to or greater than 1).

The memory controller 100 may control the storage device 200 in response to a request from the external device. For example, the memory controller 100 may enable data to be programmed in the storage device 200 in response to a write request from the external device. Furthermore, the memory controller 100 may provide the external device with data that has been recorded on the storage device 200, in response to a read request from the external device.

The memory controller 100 may include at least one processor (CPU(s)) 111, an external interface circuit 113, a storage interface circuit 115, memory 117, an error correction circuit (ECC) 119), and a maintenance circuit 30.

The processor 111 may be configured to operate by executing, in hardware, firmware or software that is provided for various operations of the memory system 10. The processor 111 may have a form in which hardware and firmware or software that operates in the hardware have been combined. In an embodiment, the processor 111 may perform a function of a flash transport layer (FTL) for managing the storage device 200, for example, garbage collection, address mapping, or wear leveling.

The external interface circuit 113 may receive a command and a clock signal from the external device and provide a communication channel for controlling the input and output of data, under the control of the processor 111. In particular, the external interface circuit 113 may provide a physical connection between the external device and the memory system 10.

In an embodiment, the external interface circuit 113 may communicate with the external device based on an interface that uses at least one of various interface protocols, such as a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA (SATA) protocol, a parallel-ATA (PATA) protocol, a small computer small interface (SCSI) protocol, an enhanced small disk interface (ESDI) protocol, an integrated drive electronics (IDE) protocol, a private protocol, a system management bus (SMBus) protocol, an inter-integrated circuit (I2C) protocol, and an improved inter-integrated circuit (I3C) protocol.

The storage interface circuit 115 may provide a communication channel for the transmission and reception of signals between the memory controller 100 and the storage device 200. The storage interface circuit 115 may write, in the storage device 200, data that has been temporarily stored in buffer memory (not illustrated) under the control of the processor 111. Furthermore, the storage interface circuit 115 may temporarily store, in the buffer memory (not illustrated), data that is read from the storage device 200 by transferring the data to the buffer memory. The buffer memory may be provided inside and/or outside the memory controller 100.

The memory 117 may store data that is necessary for an operation of the memory controller 100 or data that has been generated by the memory controller 100.

The ECC 119 may store, in the storage device 200, data that is provided by the external device or the processor 111 by encoding the data in a set way, and may provide the external device or the processor 111 with data that has been read from the storage device 200 by decoding the data in a set way and correcting an error of the data.

The maintenance circuit 30 may perform a maintenance operation on data that has been stored in the storage device 200.

The maintenance operation may be a “scan and refresh” operation of entering a maintenance mode every preset cycle, reading (or scanning) data that has been stored in a specific page(s) for each memory block that constitutes the storage device 200, and refreshing data of a memory block that includes a corresponding page when a fail bit having a threshold or more is detected. A read operation for scan and refresh may be referred to as a “test read” operation. A read operation based on an internal or external command may be referred to as a “normal read” operation. The word “preset” as used herein with respect to a parameter, such as a preset map information update condition, means that a value for the parameter is determined prior to the parameter being used in a process or algorithm. For some embodiments, the value for the parameter is determined before the process or algorithm begins. In other embodiments, the value for the parameter is determined during the process or algorithm but before the parameter is used in the process or algorithm. The word “predetermined” as used herein with respect to a parameter, such as a predetermined cycle, means that a value for the parameter is determined prior to the parameter being used in a process or algorithm. For some embodiments, the value for the parameter is determined before the process or algorithm begins. In other embodiments, the value for the parameter is determined during the process or algorithm but before the parameter is used in the process or algorithm.

The maintenance circuit 30 according to this technology may perform a test read operation with reference to a weak page table. The weak page table may store the set number of page addresses, that is, a test read target. The maintenance circuit 30 may construct an initial weak page table by detecting a health condition of pages, that is, the set number of weak page sets having a weak memory retention characteristic, through a test before the memory system 10 is shipped. As another example, the initial weak page table may be constructed by randomly selecting the set number of page address sets.

As the memory system 10 operates, a health condition of pages may be changed. The maintenance circuit 30 may update a weak page table by incorporating the health condition of the pages.

In a nonvolatile memory device such as a flash memory device, when a read operation for a specific page is repeated, threshold voltage levels of memory cells that are included in the specific page may be changed, so that data that has been stored in the memory cells may be damaged. Such a phenomenon may be called read disturbance. Read disturbance acts as a cause for increasing a read error occurrence rate. Accordingly, in an embodiment, a weak page table may dynamically change by incorporating a phenomenon, such as read disturbance.

For example, when a command that is accompanied by a normal read operation is executed in the memory system 10, an error of read data may be detected through the ECC 119. To execute the command accompanying the normal read operation, the memory system 10 may access at least one page to be read stored data. The maintenance circuit 30 may update a weak page table by checking the number of fail bits for each page that has been read by the normal read operation. In an embodiment, the weak page table may be updated to include the set number of page addresses in order of a greater number of fail bits. The weak page table may be updated fully or partially.

As the weak page table is updated by incorporating a change in the health condition of pages that constitute the storage device 200, the data of a page having a weak data retention characteristic can be safely protected.

FIG. 3 is a construction diagram of the maintenance circuit according to an embodiment.

Referring to FIG. 3, the maintenance circuit 30 may include a weak page table 310, scan/refresh logic 320, and a weak page tracking circuit 330.

The weak page table 310 may include at least a first weak page table. The first number of page address sets that has been selected through a test before the memory system 10 is shipped or that has been randomly selected may be stored in the first weak page table as an initial value. The first weak page table may be dynamically changed based on a health condition for each page, which is changed as the memory system 10 operates. In an embodiment, the first weak page table may be at least partially updated or maintained as a command that is accompanied by a normal read operation is processed in the memory system 10.

The weak page table 310 may further include a second weak page table in which the second number of page address sets that is equal to or different from the first number is stored. The second weak page table may be constructed by detecting a health condition of pages, that is, the second number of weak page sets having a weak memory retention characteristic, through a test before the memory system 10 is shipped. The second weak page table can be maintained without being changed while the lifespan of the memory system 10 is maintained.

The scan/refresh logic 320 may enter the maintenance mode every preset cycle, and may perform a maintenance operation on the storage device 200 based on a page address that has been stored in the weak page table 310. The maintenance operation may be an operation of test-reading the data of a page address that is indicated by the weak page table 310 and refreshing the data of a corresponding memory block when a fail bit having a threshold or more is detected. A refresh operation may include an operation of reading the data of a specific memory block, correcting an error of the data, and storing the corrected data in another memory block. A read operation that is accompanied by the refresh operation may be a kind of normal read operation.

The weak page tracking circuit 330 may check the number of fail bits for each read target page when an internal or external command that is accompanied by a normal read operation is executed, may select the first number of page addresses in order of a greater number of fail bits, and may at least partially update or maintain the weak page table 310.

The command that is accompanied by the normal read operation may include a read command by the external device, and a wear leveling command, a garbage collection command, and a refresh command by the processor 111.

Accordingly, the weak page tracking circuit 330 may at least partially update or maintain the weak page table 310 by checking the number of fail bits for each page of a memory block, that is, a refresh target by the scan/refresh logic 320.

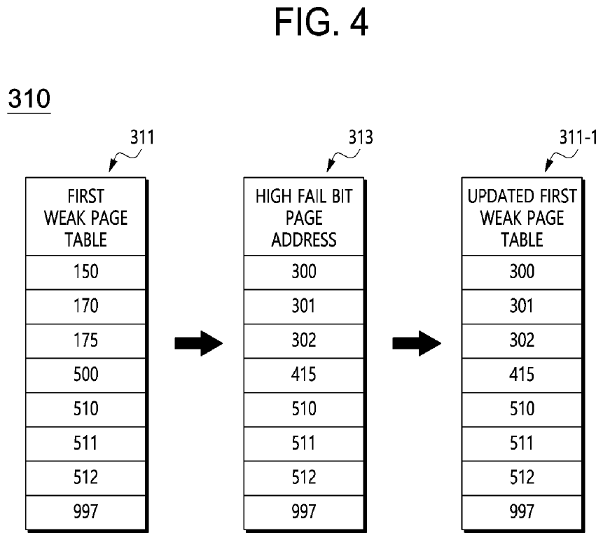

FIG. 4 is a diagram for describing the concept of a weak page table update according to an embodiment.

Referring to FIG. 4, the weak page table 310 may include a first weak page table 311, that is, a dynamic weak page table which may vary as the memory system 10 operates.

The first number of page addresses 150, 170, 175, 500, 510, 511, 512, and 997 may be stored in the first weak page table 311.

As a command that is accompanied by a normal read operation is processed, a candidate list 313 including the third number of page addresses 300, 301, 302, 415, 510, 511, 512, and 997 that is equal to or different from the first number may be detected in order of many fail bits.

The weak page tracking circuit 330 may construct an updated first weak page table 311-1 by selecting the first number of page addresses in order of a greater number of fail bits based on the number of fail bits for each page address that is included in the first weak page table 311 and the number of fail bits for each page address that is included in the candidate list 313.

FIG. 4 illustrates an example in which the first weak page table has been updated (311-1) with the page addresses 300, 301, 302, and 415 having a greater number of fail bits than the page addresses 150, 170, 175, and 500 that are included in the first weak page table 311.

If a candidate list having a greater number of fail bits than the number of fail bits for each page address that is included in the first weak page table 311 is not detected, the first weak page table may be maintained without an update.

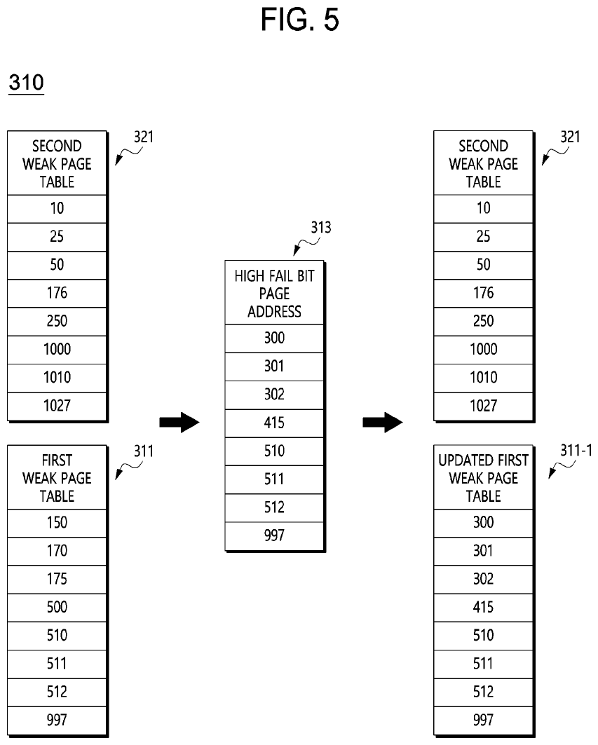

FIG. 5 is a diagram for describing the concept of a weak page table update according to an embodiment.

Referring to FIG. 5, a weak page table 310 may include a first weak page table 311 and a second weak page table 321.

The first weak page table 311 may be updated and maintained by the method that has been described with reference to FIG. 4.

A second weak page table 321 may be constructed by detecting a health condition of pages, that is, the second number of weak pages having a weak memory retention characteristic, through a test before the memory system 10 is shipped. The second weak page table 321 may be a static weak page table which is maintained without being changed although the first weak page table 311 is updated (311-1).

A method of constructing the second weak page table 321 is not limited to the above method, but may include various methods of constructing the second weak page table 321 by randomly selecting the second number of page addresses or using the second number of specific page addresses.

The weak page table 310 may be stored in the memory 117 of the memory controller 100.

FIG. 5 has illustrated the first weak page tables 311 and 311-1 and the second weak page table 321 as separate tables in order to help conceptual understanding, but this technology is not limited thereto. For example, a page address that is included in the first weak page table may be stored and updated in a part of a weak page table storage region, and a page address that is included in the second weak page table may be stored in another region of the weak page table storage region.

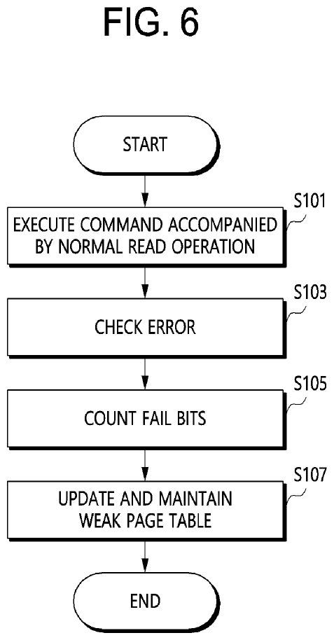

FIG. 6 is a flowchart for describing an operating method of the memory system according to an embodiment, and illustrates an example of a method of updating a weak page table.

Referring to FIG. 6, the memory controller 100 may detect an error of read data (S103) by executing a command that is accompanied by a normal read operation (S101).

The command that is accompanied by the normal read operation may include a read command by the external device, and a wear leveling command, a garbage collection command, and a refresh command by the processor 111.

The memory controller 100 may update a weak page table (S107) by counting the number of fail bits for each page that has been read by the normal read operation (S105). In an embodiment, the memory controller 100 may at least partially update or maintain the weak page table by selecting the set number of page addresses in order of a greater number of fail bits.

The weak page table may include a first weak page table that is dynamically changed and a second weak page table that is maintained without a change. The first weak page table may be changed or maintained by a normal read operation.

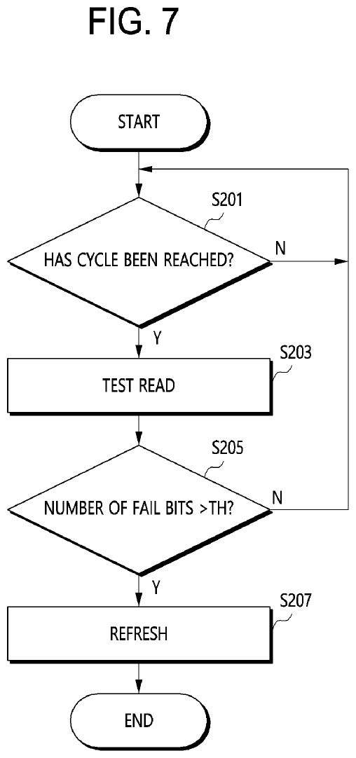

FIG. 7 is a flowchart for describing an operating method of the memory system according to an embodiment, and illustrates an example of a maintenance method using a weak page table.

Referring to FIG. 7, the memory controller 100 may check whether a preset cycle in which the maintenance mode is to be reached has been reached (S201). If the preset cycle has not been reached (N in S201), the memory controller 100 may continuously monitor whether the preset cycle has been reached.

If the preset cycle has been reached (Y in S201), the memory controller 100 may test-read data indicated by a page address that has been stored in a weak page table (S203).

The memory controller 100 may check whether the number of fail bits greater than a threshold TH is detected by checking an error of the test-read data (S205). When the number of fail bits is equal to or smaller than the threshold TH (N in S205), the memory controller 100 may terminate the maintenance mode and monitor whether the preset cycle has been reached (S201).

When the number of fail bits greater than the threshold TH is detected (Y in S205), the memory controller 100 may refresh the data of a memory block that includes a corresponding page (S207).

In an embodiment, the refresh operation in step S207 may include an operation of reading the data of a corresponding memory block, correcting an error of the read data, and storing the corrected data in another memory block. A weak page table may be updated and maintained by detecting the number of fail bits through a read operation that is accompanied by a refresh operation.

As the memory system 10 operates, a location of a weak page may be changed. The data of a page having a weak disturbance characteristic can be safely stored in a way to perform test read and refresh by using a weak page table that is constructed by incorporating a change in the location of the weak page.

According to this technology, in an embodiment, error information may be collected when data is read in response to an internal or external command. The data of a memory region having a weak health condition can be refreshed by using the error information.

Accordingly, in an embodiment, a loss of data can be prevented or mitigated, and the reliability of data can be improved because a maintenance operation is performed adaptively to a change in the characteristic of a memory device.

As described above, a person skilled in the art to which the present disclosure pertains can understand that the present disclosure may be carried out in other specific forms without changing its technical spirit or essential features. Therefore, it should be understood that the embodiments described above are illustrative in all aspects, not limitative. The scope of the present disclosure is defined by the claims to be described below rather than the detailed description, and it should be construed that the meaning and scope of the claims and all changes or modified forms derived from the equivalent concept thereof are included in the scope of the present disclosure.

What is claimed is:

1. A memory system comprising:
a storage device comprising a plurality of memory blocks comprising a plurality of pages; and
a memory controller configured to update and maintain a page address that is included in a weak page table, based on a number of fail bits for each page that has been accessed based on a page address on which a normal read operation has been indicated, and configured to perform a maintenance operation on the storage device every preset cycle based on the weak page table.

2. The memory system of claim 1, wherein the maintenance operation comprises an operation of reading data that has been stored in a page indicated by a page address that has been stored in the weak page table and refreshing data of a memory block comprising a page having a number of detected fail bits greater than a threshold.

3. The memory system of claim 1, wherein the memory controller is configured to at least partially update and maintain the weak page table by selecting a set number of page addresses in order of a greater number of fail bits.

4. The memory system of claim 1, wherein the weak page table is configured to comprise:
a first weak page table in which a first page address set that has been initially stored is at least partially updated or maintained by the normal read operation; and
a second weak page table in which a second page address set that has been initially stored is maintained.

5. The memory system of claim 4, wherein the memory controller is configured to at least partially update and maintain the weak page table by selecting a set number of page addresses in order of a greater number of fail bits based on a number of fail bits for each page address that is included in the first page address set and a number of fail bits for each page that has been accessed when the normal read operation is performed.

6. The memory system of claim 1, wherein the normal read operation is configured to comprise a read command by an external device or at least one of a wear leveling command, a garbage collection command, and a refresh command by the memory controller.

7. A memory controller comprising:
a weak page table in which a set number of page addresses have been stored;
scan and refresh (scan/refresh) logic configured to perform a maintenance operation by accessing a storage device every preset cycle based on the weak page table; and
a weak page tracking circuit configured to update and maintain a page address that is included in the weak page table, based on a number of fail bits for each page that has been accessed based on a page address on which a normal read operation has been indicated.

8. The memory controller of claim 7, wherein the scan/refresh logic controls the maintenance operation so that data that has been stored in a page indicated by a page address that has been stored in the weak page table is read and data of a memory block comprising a page having a number of detected fail bits greater than a threshold is refreshed.

9. The memory controller of claim 7, wherein the weak page tracking circuit is configured to at least partially update and maintain the weak page table by selecting a set number of page addresses in order of a greater number of fail bits.

10. The memory controller of claim 7, wherein the weak page table is configured to comprise:
a first weak page table in which a first page address set that has been initially stored is at least partially updated or maintained by the normal read operation; and
a second weak page table in which a second page address set that has been initially stored is maintained.

11. The memory controller of claim 10, wherein the weak page tracking circuit is configured to at least partially update and maintain the weak page table by selecting a set number of page addresses in order of a greater number of fail bits based on a number of fail bits for each page address that is included in the first page address set and a number of fail bits for each page that has been accessed when the normal read operation is performed.

12. The memory controller of claim 7, wherein the normal read operation is configured to comprise a read command by an external device or at least one of a wear leveling command, a garbage collection command, and a refresh command by the memory controller.

13. An operating method of a memory system, comprising:
reading, by a memory controller configured to control a storage device comprising a plurality of memory blocks comprising a plurality of pages, data by accessing a page corresponding to a page address on which a normal read operation has been indicated;
updating and maintaining, by the memory controller, a page address that is included in a weak page table, based on a number of fail bits for each page accessed for the normal read operation; and
performing, by the memory controller, a maintenance operation every preset cycle based on the weak page table.

14. The operating method of claim 13, wherein the maintenance operation comprises an operation of reading data that has been stored in a page indicated by a page address that has been stored in the weak page table and refreshing data of a memory block comprising a page having a number of detected fail bits greater than a threshold.

15. The operating method of claim 13, wherein the memory controller is configured to at least partially update and maintain the weak page table by selecting a set number of page addresses in order of a greater number of fail bits.

16. The operating method of claim 13, wherein the weak page table is configured to comprise:
a first weak page table in which a first page address set that has been initially stored is at least partially updated or maintained by the normal read operation; and
a second weak page table in which a second page address set that has been initially stored is maintained.

17. The operating method of claim 16, wherein the memory controller is configured to at least partially update and maintain the weak page table by selecting a set number of page addresses in order of a greater number of fail bits based on a number of fail bits for each page address that is included in the first page address set and a number of fail bits for each page that has been accessed when the normal read operation is performed.

18. The operating method of claim 13, wherein the normal read operation is configured to comprise a read command by an external device or at least one of a wear leveling command, a garbage collection command, and a refresh command by the memory controller.
